(19) United States
(12) Patent Application Publication
(10) Pub. No.: US 2009/0106437 A1
(43) Pub. Date: Apr. 23, 2009

(54) Method and device for handling different addressing schemes in session initiation protocol communication

(75) Inventors: Miraj Mostafa, Tampere (FI); Catalin Ionescu, Tampere (FI)

Correspondence Address: HARRINGTON & SMITH, PC, 4 RESEARCH DRIVE, Suite 202, SHELTON, CT, 06484-6212, US

(73) Assignee: Nokia Corporation

(21) Appl. No.: 11/975,782

(22) Filed: Oct. 22, 2007

(51) Int. Cl. G06F 15/16

(52) U.S. Cl. 709/230

(57) ABSTRACT

A method including sending a request for a Session Initiation Protocol (SIP) service, the request including at least one Universal Resource Identifier (URI) according to a first addressing scheme. The method further includes receiving a response including the URI of the first addressing scheme, a corresponding SIP URI for each URI of the first addressing scheme, and information associating each URI of the first addressing scheme with the corresponding SIP URI. The method further includes mapping each SIP URI to the corresponding URI of the first addressing scheme on the basis of the associating information. A device and a computer program product relating to the method are also described.

The present invention relates to methods and devices for handling different addressing schemes used in Session Initiation Protocol (SIP) communication. It particularly relates to methods and devices allowing the handling of addresses in End-to-End (E2E) SIP communication that are associated with the same entity but can not readily be translated.

### BACKGROUND OF THE INVENTION

SIP is a text-based protocol for initiating interactive communication sessions between users. Such sessions include voice, video, chat, interactive games, and virtual reality. SIP was defined by the Internet Engineering Task Force (IETF) with the requirement of using SIP Uniform Resource Identifier (URI) to address a user, e.g. “sip:user@example.domain”. However, users are used to using a Mobile Subscriber/Station Integrated Services Digital Network Number (MSISDN) to address other users, e.g. +49-89-1234567.

Support for MSISDN was introduced in the IP Multimedia Subsystem (IMS) defined by the 3^{rd} Generation Partnership Project (3GPP) in terms of a so-called “tel URI”, in the form of “tel:+49-89-1234567”. The idea here is that a user continues to use MSISDN numbers while a client converts an MSISDN to the corresponding tel URI when sending any request to a network. It is expected that the operators would deploy SIP services based on MSISDN number at the beginning. So, it is important to have end-to-end (E2E) solution for having SIP services based on MSISDN. “Presence” and Push-to-talk over Cellular (PoC) are example SIP services that are already standardized by the Open Mobile Alliance (OMA). Other SIP-based services being standardized in OMA are Instant Messaging (IM) and gaming. Additional to the standard services there are non-standard SIP-based services like video sharing.

The way it is defined for IMS in 3GPP and OMA, a SIP request with a tel URI can be routed within the home domain. The request is delivered to any application server (AS) as such with the tel URI. If the request is routed to a foreign domain, the tel URI is converted to a SIP URI, and upon receiving the request in the foreign domain, the SIP URI is again converted back to the tel URI. So, an AS always receives the request with a tel URI and then converts it into a SIP URI before any further processing. The response, sent back to the client by the AS, includes only the SIP URI. Any message sent to the client (by the AS) as part of the dialogue also includes the SIP URI.

The client can become confused getting back a SIP URI (instead of the tel URI that the client knows), and may not be able to map the SIP URI back to tel URI. The situation is more challenging for the client if the initial request was sent for a list/group of users, where some of the list/group members are addressed with tel URIs. In this case, all the tel URIs are converted to SIP URIs and the client has no clue at all about what SIP URL corresponds to which tel URI.

### SUMMARY OF THE INVENTION

According to a first aspect of the invention a method is provided, comprising
sending a request for a Session Initiation Protocol (SIP) service, said request including at least one Universal Resource Identifier (URI) according to a first addressing scheme;
receiving a response including said at least one URI of said first addressing scheme, a corresponding SIP URI for each URI of said first addressing scheme, and information associating each URI of said first addressing scheme with the corresponding SIP URI; and
mapping each SIP URI to the corresponding URI of said first addressing scheme, on the basis of said associating information.

The invention allows the use of URIs according to a non-SIP URI addressing scheme in End-to-End SIP communications in a transparent manner.

According to an exemplary embodiment said SIP service is at least one of
voice service;
video service;
instant messaging service;
interactive game service;
virtual reality service;
Push-to-talk over Cellular service (PoC); and
Presence service.

According to an exemplary embodiment
said SIP service is a Presence service;
said response is a SIP NOTIFY request with a Resource List Meta-Information (RLMI) part listing at least one presentity and a part comprising presence information of said at least one presentity;
said RLMI part comprises said at least one URI of said first addressing scheme and said associating information; and
said presence part comprises said corresponding SIP URIs.

According to an exemplary embodiment
said SIP service is a Presence service;
said response is a SIP NOTIFY request with a Resource List Meta-Information (RLMI) part listing at least one presentity and a part comprising presence information of said at least one presentity;
said presence part comprises said at least one URI of said first addressing scheme; and
said RLMI part comprises said corresponding SIP URIs and said associating information.

According to an exemplary embodiment
said first addressing scheme is the SIP tel URI scheme.

According to a second aspect of the invention a method is provided, comprising
receiving a request for a Session Initiation Protocol (SIP) service, said request including at least one Universal Resource Identifier (URI) according to a first addressing scheme;
converting each URI according to said first addressing scheme into a corresponding SIP URI;
generating a response for said request, said response including said at least one URI of said first addressing scheme, said corresponding SIP URI for each URI of said first addressing scheme, and information associating each URI of said first addressing scheme with said SIP URI; and
sending said response.

According to an exemplary embodiment said SIP service is at least one of
voice service;
video service;
instant messaging service;
interactive game service;
virtual reality service;
Push-to-talk over Cellular service (PoC); and
Presence service.

According to an exemplary embodiment
said SIP service is a Presence service;
said response is a SIP NOTIFY request with a Resource List Meta-Information (RLMI) part listing at least one presentity and a part comprising presence information of said at least one presentity;
said RLMI part comprises said at least one URI of said first addressing scheme and said associating information; and
said presence part comprises said corresponding SIP URIs.

According to an exemplary embodiment
said SIP service is a Presence service;
said response is a SIP NOTIFY request with a Resource List Meta-Information (RLMI) part listing at least one presentity and a part comprising presence information of said at least one presentity;
said presence part comprises said at least one URI of said first addressing scheme; and
said RLMI part comprises said corresponding SIP URIs and said associating information.

According to an exemplary embodiment
said first addressing scheme is the SIP tel URI scheme.

According to a third aspect of the invention a device is provided, comprising
a network interface configured for communication with packet-switched networks;
a controller configured for sending a request for a Session Initiation Protocol (SIP) service via said network interface, said request including at least one Universal Resource Identifier (URI) according to a first addressing scheme, for receiving a response to said request via said network interface, said response including said at least one URI of said first addressing scheme, a corresponding SIP URI for each URI of said first addressing scheme, and information associating each URI of said first addressing scheme with said corresponding SIP URI, and for mapping each SIP URI to the corresponding URI of said first addressing scheme, on the basis of said associating information.

According to an exemplary embodiment said SIP service is at least one of
voice service;
video service;
instant messaging service;
interactive game service;
virtual reality service;
Push-to-talk over Cellular service (PoC); and
Presence service.

According to an exemplary embodiment
said SIP service is a Presence service;
said response is a SIP NOTIFY request with a Resource List Meta-Information (RLMI) part listing at least one presentity and a part comprising presence information of said at least one presentity;
said RLMI part comprises said at least one URI of said first addressing scheme; and
said presence part comprises said corresponding SIP URIs.

According to an exemplary embodiment
said SIP service is a Presence service;
said response is a SIP NOTIFY request with a Resource List Meta-Information (RLMI) part listing at least one presentity and a part comprising presence information of said at least one presentity;
said RLMI part comprises said at least one URI of said first addressing scheme; and
said presence part comprises said corresponding SIP URIs.

According to an exemplary embodiment
said first addressing scheme is the SIP tel URI scheme.

According to a fourth aspect of the invention a device is provided, comprising
a network interface configured for communication with packet-switched networks;
a controller configured for receiving a request for a Session Initiation Protocol (SIP) service, said request including at least one Universal Resource Identifier (URI) according to a first addressing scheme, converting each URI according to said first addressing scheme into a corresponding SIP URI, for generating a response for said request, said response including said at least one URI of said first addressing scheme, said corresponding SIP URI for each URI of said first addressing scheme, and information associating each URI of said first addressing scheme with said SIP URI, and for sending said response.

According to an exemplary embodiment said SIP service is at least one of
voice service;
video service;
instant messaging service;
interactive game service;
virtual reality service;
Push-to-talk over Cellular service (PoC); and
Presence service.

According to an exemplary embodiment
said SIP service is a Presence service;
said response is a SIP NOTIFY request with a Resource List Meta-Information (RLMI) part listing at least one presentity and a part comprising presence information of said at least one presentity;
said RLMI part comprises said at least one URI of said first addressing scheme; and
said presence part comprises said corresponding SIP URIs.

According to an exemplary embodiment
said SIP service is a Presence service;
said response is a SIP NOTIFY request with a Resource List Meta-Information (RLMI) part listing at least one presentity and a part comprising presence information of said at least one presentity;
said presence part comprises said at least one URI of said first addressing scheme; and
said RLMI part comprises said corresponding SIP URIs.

According to an exemplary embodiment
said first addressing scheme is the SIP tel URI scheme.

According to another aspect of the invention a computer program product is provided, comprising program code stored on a computer readable medium to instruct a device on which said program product runs to
send a request for a Session Initiation Protocol (SIP) service, said request including at least one Universal Resource Identifier (URI) according to a first addressing scheme;
receive a response to said request, said response including said at least one URI of said first addressing scheme, a corresponding SIP URI for each URI of said first addressing scheme, and information associating each URI of said first addressing scheme with said corresponding SIP URI; and
map each SIP URI to the corresponding URI of said first addressing scheme, on the basis of said associating information.

According to an exemplary embodiment said SIP service is at least one of
voice service;
video service;
instant messaging service;
interactive game service;
virtual reality service;
Push-to-talk over Cellular service (PoC); and
Presence service.

According to an exemplary embodiment
said SIP service is a Presence service;
said response is a SIP NOTIFY request with a Resource List Meta-Information (RLMI) part listing at least one presentity and a part comprising presence information of said at least one presentity;
said RLMI part comprises said at least one URI of said first addressing scheme and said associating information; and
said presence part comprises said corresponding SIP URIs.

According to an exemplary embodiment
said SIP service is a Presence service;
said response is a SIP NOTIFY request with a Resource List Meta-Information (RLMI) part listing at least one presentity and a part comprising presence information of said at least one presentity;
said presence part comprises said at least one URI of said first addressing scheme; and
said RLMI part comprises said corresponding SIP URIs and said associating information.

According to an exemplary embodiment
said first addressing scheme is the SIP tel URI scheme.

According to yet another aspect of the invention a computer program product is provided, comprising program code stored on a computer readable medium to instruct a device on which said program product runs to
receive a request for a Session Initiation Protocol (SIP) service, said request including at least one Universal Resource Identifier (URI) according to a first addressing scheme;
convert each URI according to said first addressing scheme into a corresponding SIP URI;
generate a response for said request, said response including said at least one URI of said first addressing scheme, said corresponding SIP URI for each URI of said first addressing scheme, and information associating each URI of said first addressing scheme with said SIP URI; and
send said response.

According to an exemplary embodiment said SIP service is at least one of
voice service;
video service;
instant messaging service;
interactive game service;
virtual reality service;
Push-to-talk over Cellular service (PoC); and
Presence service.

According to an exemplary embodiment
said SIP service is a Presence service;
said response is a SIP NOTIFY request with a Resource List Meta-Information (RLMI) part listing at least one presentity and a part comprising presence information of said at least one presentity;
said RLMI part comprises said at least one URI of said first addressing scheme and said associating information; and
said presence part comprises said corresponding SIP URIs.

According to an exemplary embodiment
said SIP service is a Presence service;
said response is a SIP NOTIFY request with a Resource List Meta-Information (RLMI) part listing at least one presentity and a part comprising presence information of said at least one presentity;
said presence part comprises said at least one URI of said first addressing scheme; and
said RLMI part comprises said corresponding SIP URIs and said associating information.

According to an exemplary embodiment
said first addressing scheme is the SIP tel URI scheme.

### BRIEF DESCRIPTION OF THE DRAWINGS

The invention can be more fully understood by the following detailed description of exemplary embodiments, when also referring to the drawings, which are provided in an exemplary manner only and are not intended to limit the invention to any particular embodiment illustrated therein. In the drawings

FIG. 1 illustrates a flow diagram of an embodiment of the invention;

FIG. 2 illustrates a flow diagram of another embodiment of the invention;

FIG. 3 illustrates the structure of an embodiment of a message according to the invention; and

FIG. 4 shows elements of devices according to the invention.

### DETAILED DESCRIPTION OF THE INVENTION

It is to be noted that the following detailed description of the invention will mainly focus on the example of the SIMPLE presence service and therefore illustrate the invention with reference to particulars of this service and in connection with the tel URI addressing scheme as an example of an addressing scheme. However, the present invention is not restricted to the SIMPLE presence service or the tel URI scheme, but can be used with any other SIP service and with any other non-SIP URI addressing scheme, which will be readily apparent to any artisan.

SIP for Instant Messaging and Presence Leveraging Extensions (SIMPLE) presence (defined by OMA) is a SIP-based service. It is possible to store a list (e.g. buddy list) in the network (e.g. Shared XML Document Management Server, XDMS), and the list is identified by a SIP URI. The mapping happens in a Resource List Server. The list will contain the identity of resources in a certain format. It is allowed to use tel URIs for the members of a list. For example, a user may create a list for his/her friends (where he/she uses tel URIs for the friends), identified by SIP URI sip:myfriends@example.com.

Then the user wants to obtain presence information of the friends in the list. The client sends a SIP SUBSCRIBE request pointing to the SIP URI of the list. Upon receiving the request, the Resource List Server (RLS) AS retrieves the list information from the Shared XDMS, and converts all tel URIs in the group to the corresponding SIP URIs. The RLS AS then retrieves the presence information of the list members from a corresponding presence AS, and sends collective presence information of all the list members to the requesting client in terms of a SIP NOTIFY message. The SIP NOTIFY message includes only the SIP URIs of the users. As the client only knows the respective tel URI (not the SIP URI), it is confused to get back the SIP URI, and consequently it cannot map those SIP URIs back to the respective tel URIs.

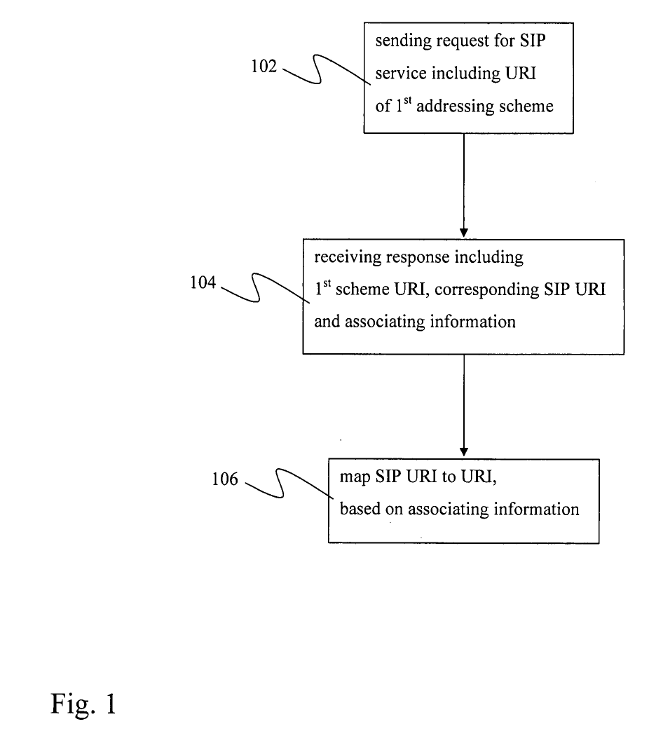

FIG. 1 illustrates a first exemplary embodiment of the present invention. In step 102 a client sends a request for a SIP service (e.g. the above mentioned SIMPLE presence), including at least one URI according to a first addressing scheme. For example the request is made to obtain presence information of the members of a buddy list as mentioned above, i.e. the at least one URI relates to at least one friend of the user. The URI(s) may be a tel URI, or some other non-SIP URI type URI.

In step 104 a response for the request is received. Conventionally such a response would include only the SIP URI(s) corresponding to the tel URI(s) (or other URI), thus making it possible that the client is not able to map the returned SIP URI to the original tel URI. According to the invention the response will include the corresponding SIP URI, the original tel URI and information enabling the client to map tel URI(s) and SIP URI(s), which is performed in step 106.

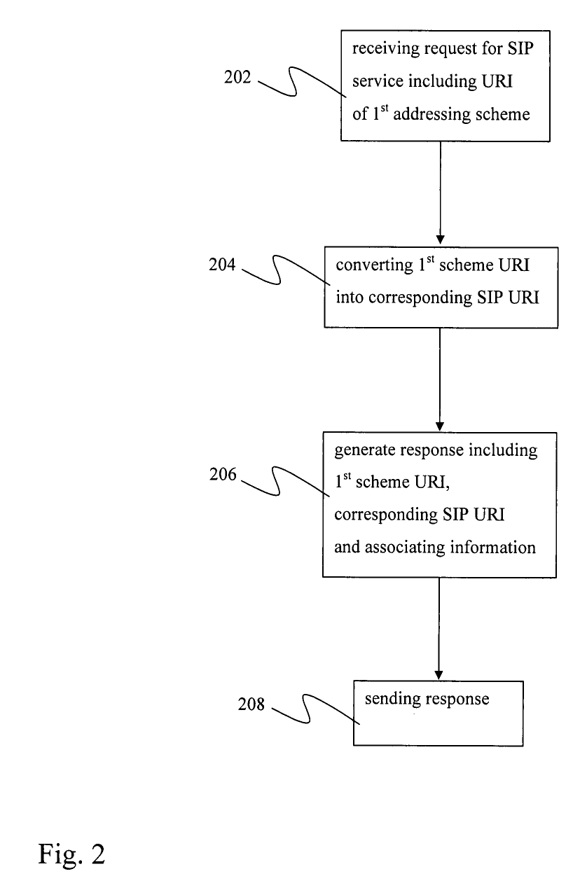

FIG. 2 illustrates a second exemplary embodiment of the present invention. In step 202 a request for a SIP service (e.g. SIMPLE presence) is received, including at least one URI of a 1^{st} addressing scheme (e.g. tel URI). In step 204 the 1^{st} scheme URI is converted into a corresponding SIP URI. In step 206 a response to the request is generated, including the 1^{st} scheme URI, the corresponding SIP URI and information associating these URIs (e.g. content-identification cid). Finally, in step 208 the generated response is sent back to the requesting client.

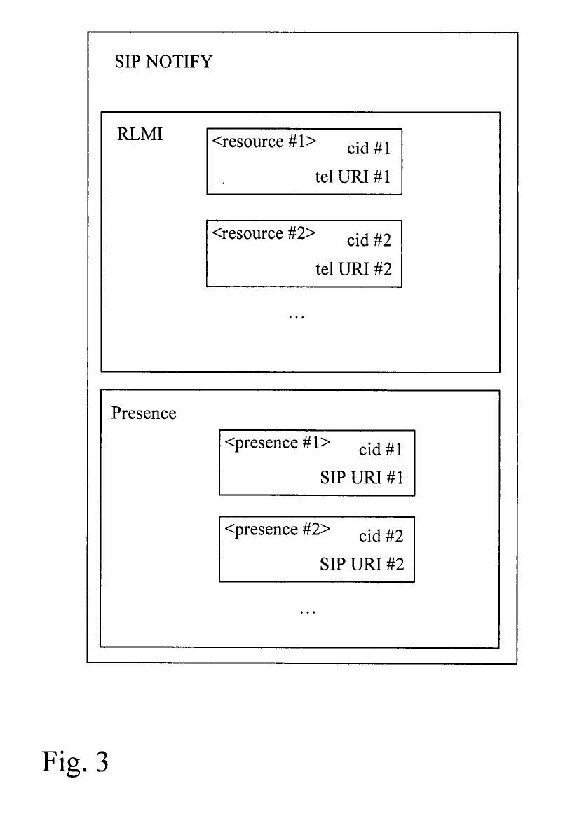

FIG. 3 illustrates, for an exemplary SIMPLE presence case, the structure of a SIP NOTIFY message that has a multipart payload. The first content part of the payload is an XML-based document known as RLMI (Resource List Meta-Information) defined by RFC 4662. The RLMI has one <resource> element for each presentity (entity that is described by presence information), whose presence information follows the RLMI. The presentities can for example be friends of the user. Within the <resource> element, the subscription status of the presentity is described (not shown). Furthermore, the <resource> element also identifies the presentity in terms of an URI as an attribute, which in this example would be a tel URI. The element also provides a pointer to that part of the multipart payload where the presence information corresponding to the presentity is available, for example a content-identification (cid).

Presence information of the presentities follows the RLMI in the SIP NOTIFY message in case of an RLS subscription. Presence information of each presentity forms a multipart object or “presence document”. Within each such object, the presence information is encapsulated within a <presence> element, where the presentity is again identified in terms of an URI as the value of the attribute entity, in the example case here a SIP URI.

So, as described above, there are two places where a URI of a presentity is included in the SIP NOTIFY message in case of RLS subscription. This invention proposes to put the same URI used in the buddy list (tel URI here) in one place, and the corresponding SIP URI in the other place.

According to the exemplary embodiment in FIG. 3 the tel URI will be located in the RLMI, so the RLMI resembles the (buddy) list. In turn the SIP URI will be located in the presence payload part. As the RLMI clearly points to the presence document for a presentity in terms of content-identification (cid), a client can now easily map the SIP URI with the tel URI, and process and present the presence information of the presentity in a systematic and organized manner. An exemplary <resource> element in the RLMI section of the RLS notification could have the form

```
<resource uri=“sip:14252238466@imsdemo.mobile.com”>
      <name>Girish S. TEST</name>
    <instance id=“1” state=“pending”
    cid=“cid1@imsdemo.mobile.com”>
    </instance>
  </resource>
```

wherein the <instance> element points to the presence document.

According to an alternative embodiment that is otherwise similar to that shown in FIG. 3 the RLMI includes the converted SIP URI, while the presence payload part or “presence document” includes the URI used in the buddy list (tel URI in this example). This option is also relevant for the case of a single subscription, as the presence document is used for both kinds of subscription, while RLMI is used only for RLS subscription. A single subscription is a direct SIP subscription towards the application server. In this case the client and the server have a direct SIP dialog.

Though only the telephone number (MSISDN) as an example of a non-SIP URI addressing scheme was mentioned above, the solution of the invention can be extended for any addressing scheme (other than SIP URI) used by a client.

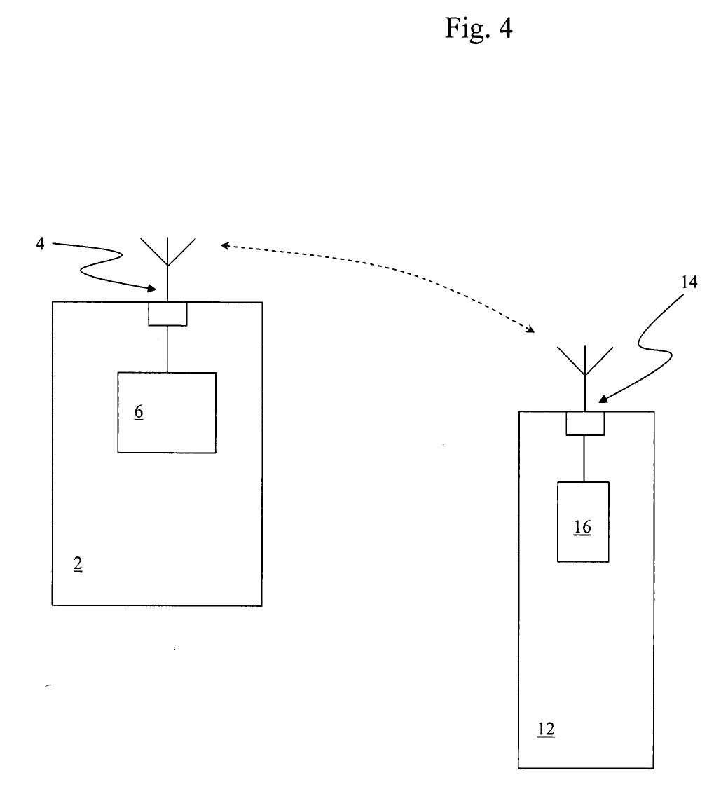

FIG. 4 shows a schematic view of devices according to the invention. A client device 2 comprises an interface to a packet-switched network, in this example a wireless network like a mobile communication network. It is to be noted that this interface can be any kind of packet-switched network interface, wired or wireless. The client device 2 is controlled by a central controller 6.

A server device 12, for example an application server (AS), comprises a packet-switched network interface corresponding to the interface 4 of the client device 2. Again, this network interface can be any kind of packet-switched network interface. The server device 12 is controlled by a central controller 16. The server device 12 can comprise further (not shown) network interfaces, for example a wired backbone connection to another application server.

The client device 2 is configured for sending a request for a Session Initiation Protocol (SIP) service via said network interface 4 to said server device 12. This request includes at least one Universal Resource Identifier (URI) according to a first addressing scheme, for example according to the tel URI scheme.

The controller 16 of the server device 12 is configured for receiving the request for the Session Initiation Protocol (SIP) service including the at least one Universal Resource Identifier (URI) according to the first addressing scheme. The controller 16 is configured for converting each URI according to said first addressing scheme into a corresponding SIP URI. In the example here the controller 16 will convert the tel URI(s) into (a) corresponding SIP URI(s).

The server device 12 will further generate a response to said request, said response including said at least one URI of said first addressing scheme, said corresponding SIP URI for each URI of said first addressing scheme, and information associating each URI of said first addressing scheme with said SIP URI. The server device 12 will perform further actions, depending on the requested SIP service. In case of the exemplary SIMPLE presence service the server device 12 will obtain the requested presence information for the presentities indicated by the included URI(s) and include the presence information in the generated response. In case of the SIMPLE presence service the response will have the form of a SIP NOTIFY message. The server device 12 will then send the generated response back to the requester, i.e. client device 2.

The client device 2 is configured for receiving the response from the server device 12, via said network interface. As the response, according to the invention, includes said at least one URI of said first addressing scheme, additional to the corresponding SIP URI, and information associating each URI of said first addressing scheme with said corresponding SIP URI, the client device 2 is able to map each SIP URI to the corresponding URI of said first addressing scheme, on the basis of said associating information. The client 2 device can now process and/or present the URI(s) in a systematic and organized way.

1. Method, comprising
sending a request for a Session Initiation Protocol (SIP) service, said request including at least one Universal Resource Identifier (URI) according to a first addressing scheme;
receiving a response including said at least one URI of said first addressing scheme, a corresponding SIP URI for each URI of said first addressing scheme, and information associating each URI of said first addressing scheme with the corresponding SIP URI; and
mapping each SIP URI to the corresponding URI of said first addressing scheme, on the basis of said associating information.

2. Method according to claim 1, wherein said SIP service is at least one of
voice service;
video service;
instant messaging service;
interactive game service;
virtual reality service;
Push-to-talk over Cellular service (PoC); and
Presence service.

3. Method according to claim 1, wherein
said SIP service is a Presence service;
said response is a SIP NOTIFY request with a Resource List Meta-Information (RLMI) part listing at least one presentity and a part comprising presence information of said at least one presentity;
said RLMI part comprises said at least one URI of said first addressing scheme and said associating information; and
said presence part comprises said corresponding SIP URIs.

4. Method according to claim 1, wherein
said SIP service is a Presence service;
said response is a SIP NOTIFY request with a Resource List Meta-Information (RLMI) part listing at least one presentity and a part comprising presence information of said at least one presentity;
said presence part comprises said at least one URI of said first addressing scheme; and
said RLMI part comprises said corresponding SIP URIs and said associating information.

5. Method according to claim 1, wherein
said first addressing scheme is the SIP tel URI scheme.

6. Method, comprising
receiving a request for a Session Initiation Protocol (SIP) service, said request including at least one Universal Resource Identifier (URI) according to a first addressing scheme;
converting each URI according to said first addressing scheme into a corresponding SIP URI;
generating a response for said request, said response including said at least one URI of said first addressing scheme, said corresponding SIP URI for each URI of said first addressing scheme, and information associating each URI of said first addressing scheme with said SIP URI; and
sending said response.

7. Method according to claim 6, wherein said SIP service is at least one of
voice service;
video service;
instant messaging service;
interactive game service;
virtual reality service;
Push-to-talk over Cellular service (PoC); and
Presence service.

8. Method according to claim 6, wherein
said SIP service is a Presence service;
said response is a SIP NOTIFY request with a Resource List Meta-Information (RLMI) part listing at least one presentity and a part comprising presence information of said at least one presentity;
said RLMI part comprises said at least one URI of said first addressing scheme and said associating information; and
said presence part comprises said corresponding SIP URIs.

9. Method according to claim 6, wherein
said SIP service is a Presence service;
said response is a SIP NOTIFY request with a Resource List Meta-Information (RLMI) part listing at least one presentity and a part comprising presence information of said at least one presentity;
said presence part comprises said at least one URI of said first addressing scheme; and
said RLMI part comprises said corresponding SIP URIs and said associating information.

10. Method according to claim 6, wherein
said first addressing scheme is the SIP tel URI scheme.

11. Computer program product, comprising program code stored on a computer readable medium to instruct a device on which said program product runs to
receive a request for a Session Initiation Protocol (SIP) service, said request including at least one Universal Resource Identifier (URI) according to a first addressing scheme;
convert each URI according to said first addressing scheme into a corresponding SIP URI;
generate a response for said request, said response including said at least one URI of said first addressing scheme, said corresponding SIP URI for each URI of said first addressing scheme, and information associating each URI of said first addressing scheme with said SIP URI; and
send said response.

12. Computer program product according to claim 11, wherein said SIP service is at least one of
voice service;
video service;
instant messaging service;
interactive game service;
virtual reality service;
Push-to-talk over Cellular service (PoC); and
Presence service.

13. Computer program product according to claim 11, wherein
said SIP service is a Presence service;
said response is a SIP NOTIFY request with a Resource List Meta-Information (RLMI) part listing at least one presentity and a part comprising presence information of said at least one presentity;
said RLMI part comprises said at least one URI of said first addressing scheme and said associating information; and
said presence part comprises said corresponding SIP URIs.

14. Computer program product according to claim 11, wherein
said SIP service is a Presence service;
said response is a SIP NOTIFY request with a Resource List Meta-Information (RLMI) part listing at least one presentity and a part comprising presence information of said at least one presentity;
said presence part comprises said at least one URI of said first addressing scheme; and
said RLMI part comprises said corresponding SIP URIs and said associating information.

15. Computer program product according to claim 11, wherein
said first addressing scheme is the SIP tel URI scheme.

16. Device, comprising
a network interface configured for communication with packet-switched networks;
a controller configured for sending a request for a Session Initiation Protocol (SIP) service via said network interface, said request including at least one Universal Resource Identifier (URI) according to a first addressing scheme, for receiving a response to said request via said network interface, said response including said at least one URI of said first addressing scheme, a corresponding SIP URI for each URI of said first addressing scheme, and information associating each URI of said first addressing scheme with said corresponding SIP URI, and for mapping each SIP URI to the corresponding URI of said first addressing scheme, on the basis of said associating information.

17. Device according to claim 16, wherein said SIP service is at least one of
voice service;
video service;
instant messaging service;
interactive game service;
virtual reality service;
Push-to-talk over Cellular service (PoC); and
Presence service.

18. Device according to claim 16, wherein
said SIP service is a Presence service;
said response is a SIP NOTIFY request with a Resource List Meta-Information (RLMI) part listing at least one presentity and a part comprising presence information of said at least one presentity;
said RLMI part comprises said at least one URI of said first addressing scheme; and
said presence part comprises said corresponding SIP URIs.

19. Device according to claim 16, wherein
said SIP service is a Presence service;
said response is a SIP NOTIFY request with a Resource List Meta-Information (RLMI) part listing at least one presentity and a part comprising presence information of said at least one presentity;
said RLMI part comprises said at least one URI of said first addressing scheme; and
said presence part comprises said corresponding SIP URIs.

20. Device according to claim 16, wherein
said first addressing scheme is the SIP tel URI scheme.

21. Device, comprising
a network interface configured for communication with packet-switched networks;
a controller configured for receiving a request for a Session Initiation Protocol (SIP) service, said request including at least one Universal Resource Identifier (URI) according to a first addressing scheme, converting each URI according to said first addressing scheme into a corresponding SIP URI, for generating a response for said request, said response including said at least one URI of said first addressing scheme, said corresponding SIP URI for each URI of said first addressing scheme, and information associating each URI of said first addressing scheme with said SIP URI, and for sending said response.

22. Device according to claim 21, wherein said SIP service is at least one of
voice service;
video service;
instant messaging service;
interactive game service;
virtual reality service;
Push-to-talk over Cellular service (PoC); and
Presence service.

23. Device according to claim 21, wherein
said SIP service is a Presence service;
said response is a SIP NOTIFY request with a Resource List Meta-Information (RLMI) part listing at least one presentity and a part comprising presence information of said at least one presentity;
said RLMI part comprises said at least one URI of said first addressing scheme; and
said presence part comprises said corresponding SIP URIs.

24. Device according to claim 21, wherein
said SIP service is a Presence service;
said response is a SIP NOTIFY request with a Resource List Meta-Information (RLMI) part listing at least one presentity and a part comprising presence information of said at least one presentity;
said presence part comprises said at least one URI of said first addressing scheme; and
said RLMI part comprises said corresponding SIP URIs.

25. Device according to claim 21, wherein
said first addressing scheme is the SIP tel URI scheme.
